(19) United States
(12) Patent Application Publication
(10) Pub. No.: US 2026/0346107 A1
(43) Pub. Date: Nov. 5, 2026

(54) MANUFACTURING METHOD AND STRUCTURE FOR A PICKLEBALL RACKET

(71) Applicant: ALAN LIN, TAICHUNG CITY (TW)

(72) Inventor: ALAN LIN, TAICHUNG CITY (TW)

(21) Appl. No.: 19/738,688

(22) Filed: Jul. 13, 2026

Related U.S. Application Data
(62) Division of application No. 18/734,591, filed on Jun. 5, 2024.

(30) Foreign Application Priority Data
Dec. 19, 2023 (TW) 112149391

(51) Int. Cl. A63B 59/42; A63B 60/54; A63B 102/08; B29C 70/30; B29C 70/48; B29K 21/00; B29K 75/00; B29K 105/08; B29K 105/20; B29K 307/04; B29K 309/08; B29K 633/04; B29L 31/52

(52) U.S. Cl. CPC A63B 59/42; A63B 60/54; B29C 70/30; B29C 70/48; A63B 2102/08; A63B 2209/02; B29K 2021/003; B29K 2075/00; B29K 2105/08; B29K 2105/20; B29K 2307/04; B29K 2309/08; B29K 2633/04; B29L 2031/5245

(57) ABSTRACT

A method for manufacturing a pickleball racket includes the following steps: (a) impregnating a composite material with resin; (b) wrapping a core mold, made of PolyMethylMethAcrylimide (PMI), with at least one location to form an elastic layer; wrapping the composite material around the elastic layer and the core mold to form a composite material layer, to form a semi-finished product; (c) placing the semi-finished product into a mold and heating the mold to a predetermined temperature to form internal pressure within the semi-finished product; (d) stopping heating and cooling the semi-finished product to solidify it; (e) removing a pickleball racket from the mold. The pickleball racket forms an integral structure in the order of a core mold, an elastomer layer, and a composite material layer. The pickleball racket is light in weight and has strength and rigidity. The striking surfaces of the pickle racket has hitting elasticity, and shock absorption.

### FIELD OF THE INVENTION

The present invention relates to a manufacturing method and structure for a racket, particularly to a pickleball racket with lightweight, excellent maneuverability, and shock absorption effects.

### BACKGROUND OF THE INVENTION

Pickleball is an emerging racquet sport in recent years, similar to a combination of tennis, badminton, and table tennis. The gameplay is closer to tennis, and pickleball courts are similar to badminton courts, with the only difference being a lower net in the middle. The rules and gameplay of pickleball are similar to tennis.

The appearance of a pickleball racket is closer to a table tennis racket and belongs to the category of rackets without a net. It mainly consists of a striking portion and a grip portion, where the striking portion is flat, and located on both sides of the racket and are usable for striking. The striking portion and grip portion are mostly integrally formed, but there are also separable techniques applied, such as disclosed in Chinese Patent No. CN213049277U, titled “Pickleball Racket with Shock-Absorbing Handle”.

In terms of material application, most pickleball rackets use carbon fiber for the outer frame and plastic materials for the interior. Depending on various needs such as frame strength, shock absorption, face rebound, face support, etc., different technological applications and variations are applied to the racket structure, material, and manufacturing processes.

For example, concerning the striking surfaces of a pickleball racket, if the shock absorption effect is better, the impact force of the pickleball is absorbed by the surface, resulting in less rebound force when hitting the ball, lower rebound sensitivity, lower face strength and hardness, heavier feel during swings, and lower maneuverability. Conversely, when the shock absorption effect of the pickleball racket is poorer, less of the pickleball's impact force is absorbed by the striking surface, resulting in greater rebound force, higher rebound sensitivity, higher face strength and hardness, lighter feel during swings, and higher maneuverability. Therefore, the structure and material of the racket affect many physical factors, resulting in various pickleball rackets with different characteristics, each suitable depending on the user's preferences and physical conditions.

Disclosed in Chinese Patent No. CN114569990A is a “Shock-Absorbing Pickleball Racket”, comprising sequentially arranged layers: a first shock-absorbing layer, a first reinforcement layer, a base layer, a second reinforcement layer, and a second shock-absorbing layer. The first and second shock-absorbing layers are made of cushioning rubber. The cushioning rubber is produced by the following steps: natural rubber and reinforcing fibers are placed into a mixer, kneaded at 140 °C for 7 minutes to obtain a masterbatch, then the masterbatch, stearic acid, accelerator, antioxidant, and sulfur are mixed and cured at 143 °C for 15-20 minutes under room temperature conditions. The rubber temperature is controlled at 110-130 °C, rolled to a thickness of 3 mm, cooled, and cut into sheets to obtain the cushioning rubber.

Another known pickleball racket structure disclosed in Chinese Patent No. CN115155026A, is a “Pickleball Racket”, comprising a racket body and a handle. The handle is connected to one end of the racket body. The racket body includes an upper panel, a lower panel, and a composite inner panel sandwiched between the upper and lower panels. The composite inner panel consists of an upper honeycomb board, a shock-absorbing layer, and a lower honeycomb board bonded together from top to bottom. Both the upper and lower honeycomb boards have a honeycomb structure. The upper and lower panels are integrally molded, uniformly enclosing the composite inner panel. Edge strips are evenly placed between the side of the composite inner panel and the upper and lower panels.

Yet another known pickleball racket structure disclosed in Chinese Patent No. CN112870660A, is a “Multi-Layer Composite Pickleball Racket”, comprising a racket board and a handle. The handle is connected to the racket board. The internal part of the racket board has a composite inner core layer, which includes at least a first inner core layer and a second inner core layer. The first inner core layer is glued to the second inner core layer, and both layers have a honeycomb structure.

The aforementioned known patent cases are all related to pickleball racket technology, with the first case focusing on the manufacturing process of pickleball rackets, while the second and third cases pertain to the structural technology of pickleball rackets. Further analysis reveals that the first and second cases primarily focus on the development of technology aimed at enhancing shock absorption or damping functions. This is achieved through the use of rubber material shock-absorbing layers, which are layered on the racket face. In the second and third cases, the racket face has a honeycomb structure, which not only maintains the rigidity of the racket face but also provides excellent durability and environmental resistance.

The aforementioned three known technologies all employ a multi-layer inner core structure to buffer the impact force of pickleballs, achieving better shock absorption effects as the technical focus. However, due to the greater consumption of impact force by pickleballs, players need to exert more force to make pickleballs travel the same distance. Additionally, when pickleballs come into contact with the racket striking surfaces, the degree of concavity of the racket striking surface is significant, leading to greater friction and making it more difficult to control the direction of the ball's rebound flight. Moreover, the honeycomb structure can produce different rebound forces when different parts such as the honeycomb frame or cells are struck. On the other hand, a higher number of cushioning core layers can increase the overall weight of the racket, resulting in a burden on the player's hands. Furthermore, pickleball rackets with enhanced shock absorption effects are not suitable for users with lower swing power, such as children and the elderly. Additionally, the production cost of honeycomb-shaped core layers is quite high, and the manufacturing process is also more cumbersome.

The present invention intends to provide a manufacturing method and structure for a racket to eliminate the shortcomings mentioned above.

### SUMMARY OF THE INVENTION

The present invention relates to a method for manufacturing a pickleball racket, comprising the following steps:
(a) resin impregnation: impregnating a composite material with resin;
(b) core wrapping: preparing a core mold made of Poly-Methyl Methacrylimide (PMI) material and being in a shape of a racket, the core mold having an elastomer located at least one location on the core mold to form an elastomer layer, wrapping the composite material around the core mold and the elastomer layer to form a composite material layer, the composite material layers, the elastomer layers, and the core mold forming a semi-finished product;
(c) heating and pressurizing: placing the semi-finished product into a mold with a cavity, heating the mold to a predetermined temperature, the core mold expanding due to heating, creating internal pressure within the semi-finished product;
(d) cooling and curing: ceasing heating to let the semi-finished product to cool and solidify, and (e) finished product molding: removing a racket finished product from the mold.

The primary purpose of the present invention is to provide a manufacturing method and structure for a pickleball racket, with the core mold made of PolyMethyl MethAcrylate (PMI) material. During the heating step, the core mold expands due to heating, simultaneously generating internal pressure to completely fill the mold cavity with semi-finished products, eliminating the need for any pressing device, thus effectively reducing manufacturing costs.

A secondary purpose of the present invention is to provide a manufacturing method and structure for a pickleball racket, where the core mold excludes a honeycomb structure, eliminating the need for a processing step to shape the core mold into a honeycomb structure. This effectively simplifies the process and saves manufacturing costs.

Another purpose of the present invention is to provide a manufacturing method and structure for a pickleball racket, where the core mold is made of PolyMethyl MethAcrylate (PMI) material instead of the conventional honeycomb structure of the elastic layer. This enhances the supportability of the striking portion, with higher hardness and rigidity, resulting in better rebound elasticity of the racket face and improved control feel for hitting direction, while still providing shock absorption.

Yet another purpose of the present invention is to provide a manufacturing method and structure for a pickleball racket, using a core mold made of PolyMethyl MethAcrylate (PMI) material as the base. Compared to the known multi-layer elastic layer structure, the overall weight of the racket is lighter, effectively reducing the burden during swinging, suitable for use by children or the elderly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the manufacturing steps of the present invention;

FIG. 2 illustrates a schematic diagram of step (b), showing the wrapping of the core mold;

FIG. 3 illustrates the mold and heating devices of the present invention;

FIG. 4 shows the racket of the present invention;

FIG. 5 is a cross sectional view of the racket of the present invention;

FIG. 6 is a cross sectional view of the striking portion of the present invention;

FIG. 7 is a cross sectional view of the racket of a second embodiment of the present invention;

FIG. 8 is a cross sectional view of the racket of a third embodiment of the present invention;

FIG. 9 is a cross sectional view of the racket of a fourth embodiment of the present invention, and

FIG. 10 is a cross sectional view of the racket of a fifth embodiment of the present invention.

### DETAILED DESCRIPTION OF THE PREFERRED EMBODIMENT

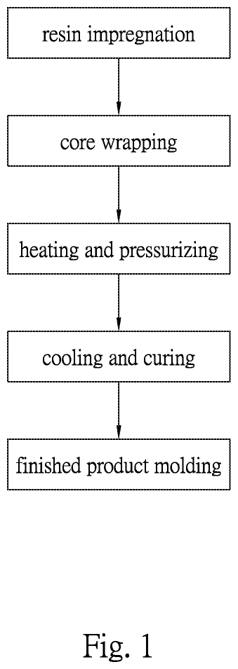

Referring to FIGS. 1 to 4, the manufacturing method of a pickleball racket of the present invention comprises the following steps:
(a) Resin impregnation: impregnating a composite material (30) with resin.
(b) Core wrapping: preparing a core mold (10) in the shape of a racket, made of PolyMethylMethAcrylimide (PMI) material. The core mold (10) is solid and has a striking portion (11) and a grip portion (12). At least one predetermined position on the core mold (10) has an elastomer (20) attached thereon, forming an elastomer layer (20′). Then, wrapping the composite material (30) around the core mold (10) and the elastomer layer (20′) to form a composite material layer (30′), where the wrapped composite material layers (30′), the elastomer layers (20′), and the core mold (10) together constitute a semi-finished product (50).
(c) Heating and pressurizing: placing the semi-finished product (50) into a mold (40) with a cavity (41), heating the mold (40) to a predetermined temperature using two heating devices (42) (43) located on both sides of the mold (40). The predetermined heating temperature exceeds the melting point of the composite material (30). The predetermined heating temperature ranges from 120 °C to 180 °C. Heating causes the core mold (10) to expand due to heat, creating internal pressure within the semi-finished product (50).
(d) Cooling and curing: ceasing heating to allow the semi-finished product (50) to cool and solidify.
(e) Finished product molding: removing a racket finished product (60) from the mold (40).

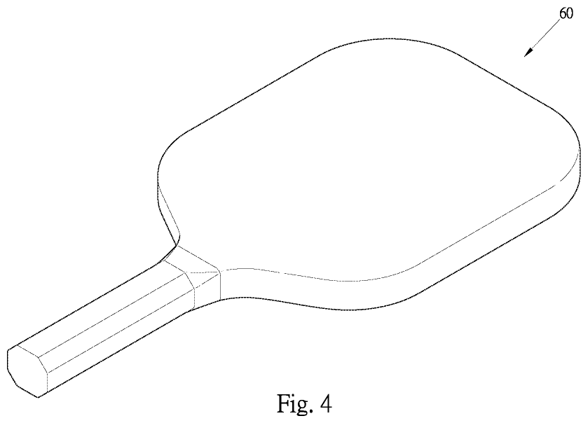

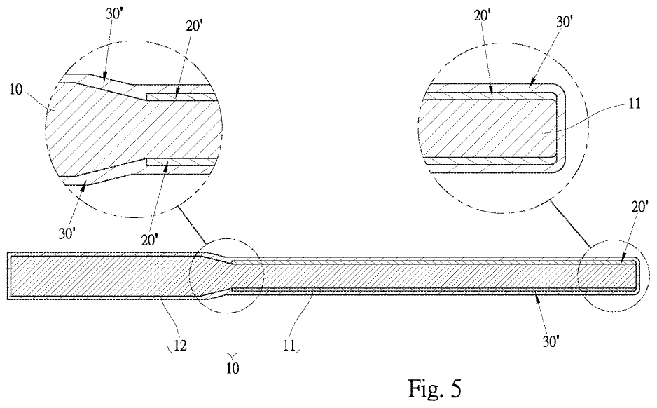

The structure of the racket finished product (60) produced by the aforementioned manufacturing method, please refer to FIGS. 4 to 6, includes a core mold (10), made of PolyMethylMethAcrylimide (PMI) material, formed integrally to include a striking portion (11) and a grip portion (12). The core mold (10) is solid.

An elastomer layer (20′), made of plastic material, covering the two striking surfaces of the striking portion (11).

A composite material layer (30′) simultaneously covering the core mold (10) and the elastomer layer (20′), forming an integral racket comprising the striking portion (11) and the grip portion (12).

Through the structure of the pickleball racket produced by the above manufacturing method, utilizing the PMI material for the core mold (10) combined with the elastomer layer (20′) on the striking surfaces of the striking portion (11), and further wrapping with the composite material (30), the integral racket is formed. Besides achieving shock absorption through the elastomer layer (20′), the striking portion (11) made of PMI material internally provides higher strength and rigidity, resulting in better rebound elasticity of the racket striking surfaces, lighter overall racket weight, improved handling, and reduced manufacturing costs, thus demonstrating high economic efficiency and practicality.

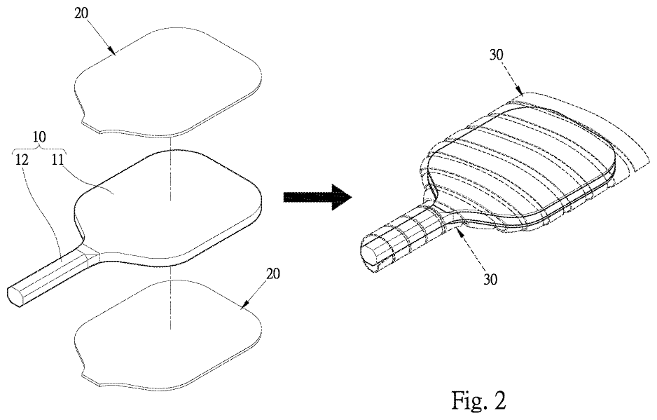

Please refer to FIGS. 1 and 2, the manufacturing method of the present invention begins with step (a) resin impregnation, where a composite material (30) is first impregnated with resin. The composite material (30) can be made of materials such as carbon fiber, glass fiber, or graphene. In step (b), the core mold (10), made of PolyMethylMethAcrylimide (PMI) material and shaped like a racket, is covered. An elastomer (20) is applied to both sides of the striking portion (11) of the core mold (10) to form an elastomer layer (20′), which can be fully or partially covered. The elastomer layer (20′) can be made of thermoplastic rubber (TPR), thermoplastic polyurethane (TPU), thermoplastic elastomer (TPE), or similar plastic materials. Next, the composite material (30) is wrapped around the core mold (10) and the elastomer layer (20′) to form a composite material layer (30′), completely covering the striking portion (11) and grip portion (12) with the elastomer layer (20′) attached. This forms a semi-finished product (50).

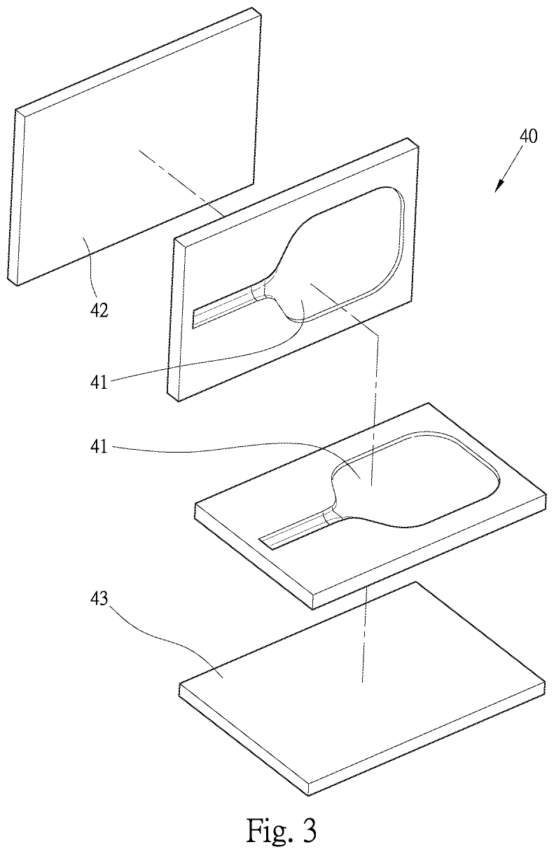

Please refer to FIG. 3, in step (c), the semi-finished product (50) is placed into the cavity (41) of the mold (40). After closing the mold (40), the heating devices (42), (43) on both sides of the mold (40) start heating it. The heating temperature exceeds the melting point of the composite material (30), approximately 120 °C to 180 °C. During heating, the core mold (10) expands due to heat, creating internal pressure inside the semi-finished product (50), filling the entire cavity (41). When the heating temperature exceeds the melting point of the composite material (30), the composite material layer (30′) softens and melts, completely covering the exterior of the semi-finished product (50).

In step (d), heating is stopped, and the semi-finished product (50) inside the mold (40) gradually solidifies to the preset temperature. Please refer to FIG. 4, in step (e), forming the finished product, a racket finished product (60) is removed from the mold (40).

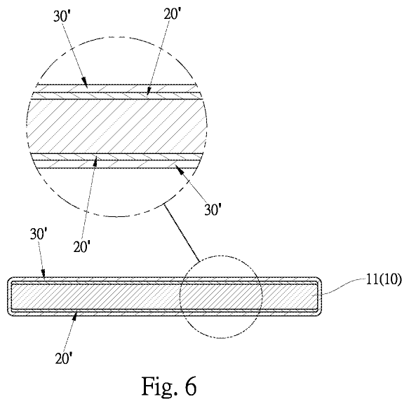

The structure of the racket finished product (60) of the present invention, as shown in FIGS. 4 and 6, includes the following components from the inside out in the striking portion (11): the core mold (10), the elastomer layer (20′), and the composite material layer (30′). In the grip portion (12), the components from the inside out are the core mold (10) and the composite material layer (30′).

The present invention utilizes five processes, including (a) resin impregnation, (b) core wrapping, (c) heating and pressurizing, (d) cooling and curing, and (e) finished product molding, to produce the pickle racket. The pickle racket is formed from the inside out, including the core mold (10), the elastomer layer (20′), and the composite material layer (30′), which collectively form an integral racket. This achieves the following benefits:

During the heating and pressurizing step (c), the core mold (10), being made of PolyMethylMethAcrylimide (PMI) material, expands when heated, creating internal pressure within the semi-finished product (50), effectively filling the mold cavity (41) without the need for additional pressure devices, thus reducing manufacturing costs.

The core mold (10) of the present invention is made of PMI material, and in the core wrapping step (b), it does not require pre-processing into a honeycomb structure. Compared to conventional techniques using honeycomb elastic layers, this simplifies the process and saves costs associated with forming the honeycomb structure.

The core mold (10) of the present invention, made of PMI material instead of a honeycomb structure, has a denser structure, resulting in consistent rebound force on various parts of the striking portion (11) upon contact with the racket ball, solving the problem of different rebound forces caused by hitting different positions on the honeycomb frame.

By using the core mold (10) made of PMI material instead of a honeycomb structure, besides retaining the damping effect, it enhances the support of the striking portion, providing higher hardness and rigidity, better rebound elasticity of the racket face, and improved control of the hitting direction. The pickleball racket of the present invention solves problems associated with increased friction and difficulty in controlling the rebound direction caused by enhanced damping functionality.

Utilizing the core mold (10) made of PMI material as the base, which occupies a larger volume of the overall racket structure, compared to conventional multi-layer elastic structures, results in a lighter overall racket weight, effectively reducing the burden during swings, making it suitable for use by children or seniors.

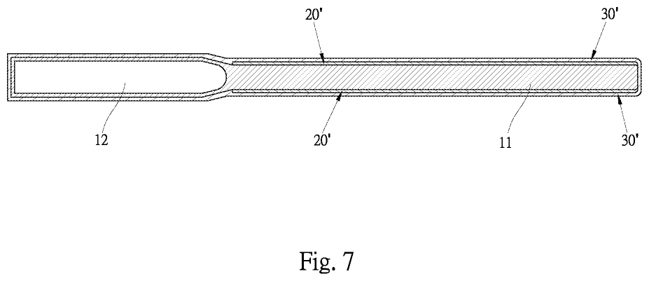

Please refer to FIG. 7, which shows the second embodiment of the present invention. In this embodiment, the core mold (10) is pre-formed with a solid striking portion (11) and a hollow grip portion (12) before processing, and then the manufacturing method of the pickleball racket of the present invention begins. The resulting racket finished product (60) has a closed hollow structure in the grip portion (12).

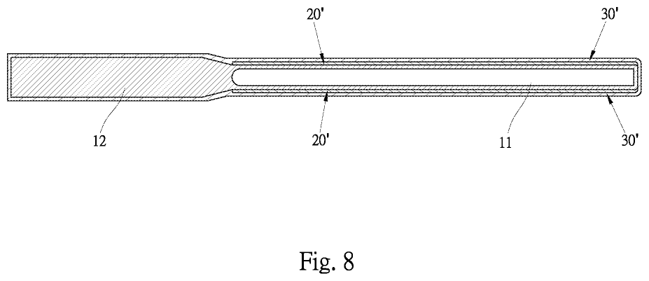

Please refer to FIG. 8, which shows the third embodiment of the present invention. In this embodiment, the core mold (10) is pre-formed with a hollow striking portion (11) and a solid grip portion (12) before processing, and then the manufacturing method of the pickleball racket of the present invention begins. The resulting racket finished product (60) has a closed hollow structure in the striking portion (11).

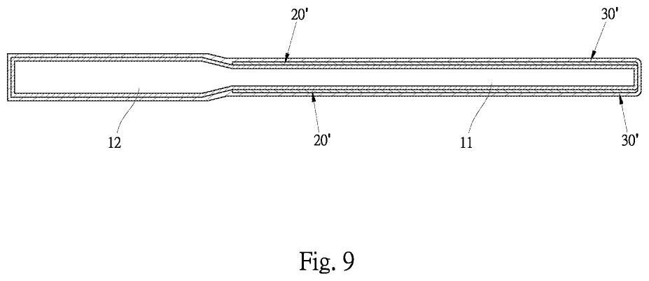

Please refer to FIG. 9, which shows the fourth embodiment of the present invention. In this embodiment, the core mold (10) is pre-formed with a hollow striking portion (11) and a hollow grip portion (12) before processing, and then the manufacturing method of the pickleball racket of the present invention begins. The resulting racket finished product (60) has closed hollow structures in both the striking portion (11) and the grip portion (12). Additionally, it is possible to form a predetermined number of spaces within the core mold (10) as needed.

The aforementioned second, third, and fourth embodiments primarily utilize variations in the internal structure of the core mold (10). The hollow structure can make the overall racket lighter, and the volume of the hollow can be adjusted as needed to produce rackets of different weights, thereby achieving the effect of adjusting the racket weight. Other manufacturing methods, structures, assembly methods, technical applications, operations, usage conditions, and expected effects of these embodiments are identical to those of the first embodiment.

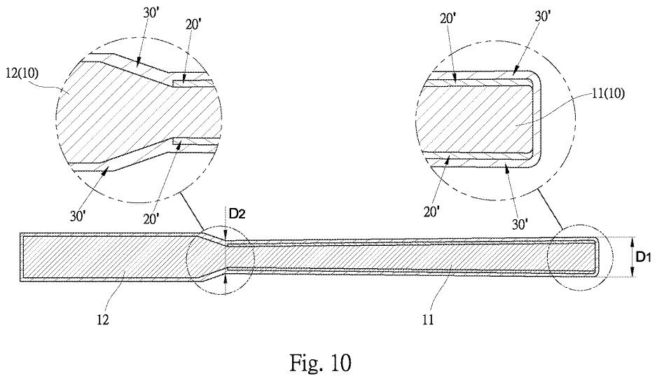

Please refer to FIG. 10, which represents the fifth embodiment of the present invention. In this embodiment, the thickness of the core mold (10) is greatest at the striking portion (11) on the distal end opposite the grip portion (12) and gradually decreases towards the grip portion (12). In other words, the thickness at the distal end of the striking portion (11) is (D1), and at a root portion of the striking portion (11) is (D2). The root portion of the striking portion (11) is at the junction with the grip portion (12). The thickness (D1) is greater than the thickness (D2), and the thickness of the striking portion (11) gradually decreases from the distal end with the thickness (D1) towards the root portion with the thickness (D2), causing the striking portion (11) to have a slightly angled slope.

This embodiment mainly provides another appearance state of the racket, where the tapered structure of the striking surfaces design can make the overall racket lighter, and the position of the overall racket's center of gravity will be different due to the different degrees of tapering, to meet the needs of different racket weight center of gravity positions, thereby achieving the effect of adjusting the racket weight center of gravity position. Other manufacturing methods, structures, assembly methods, technical applications, operations, usage conditions, and expected effects of this embodiment are identical to those of the first embodiment.

In summary, the present invention discloses a method for manufacturing a pickleball racket and its structure, which uses five steps including resin impregnation, core wrapping, heating and pressurizing, cooling and curing, and finished product molding to produce a pickleball racket. The structure of the pickleball racket is formed from the inside out in the order of the core mold, the elastomer layer, and the composite material layer, collectively forming an integral racket. In addition to achieving shock absorption through the elastomer layer, the striking portion is made of PolyMethylMethAcrylimide (PMI) material, which has higher strength and rigidity, providing better rebound elasticity of the racket face, reducing the overall racket weight, improving control feel, and reducing manufacturing costs.

While we have shown and described the embodiment in accordance with the present invention, it should be clear to those skilled in the art that further embodiments may be made without departing from the scope of the present invention.

What is claimed is:

1. A pickleball racket comprising:
a core mold (10) made of Poly-Methyl Methacrylimide (PMI) material and including integrally a striking portion (11) and a grip portion (12);
an elastomer layer (20′) made of plastic material and attached to two striking surfaces of the striking portion (11), and
a composite material layer (30′) covering each of the core mold (10) and the elastomer layer (20′), forming an integral racket comprising the striking portion (11) and the grip portion (12).

2. The structure of the pickleball racket as claimed in claim 1, wherein the core mold (10) is hollow, solid, or partially hollow.

3. The structure of the pickleball racket as claimed in claim 1, wherein a thickness of the core mold (10) is thickest at the striking portion (11) on a distal end opposite to the grip portion (12), and gradually decreases towards the grip portion (12).

4. The structure of the pickleball racket as claimed in claim 1, wherein the elastomer (20) is applied to the grip portion (12).

5. The structure of the pickleball racket as claimed in claim 1, wherein the elastomer layer (20′) is TPR (thermoplastic rubber), TPU (thermoplastic polyurethane), or TPE (thermoplastic elastomer), the composite material (30′ is carbon fiber, glass fiber, or graphene.
